(19) United States
(12) Patent Application Publication
(10) Pub. No.: US 2026/0320640 A1
(43) Pub. Date: Oct. 15, 2026

(54) COMPETITION SYSTEM FOR WINNING AN ECONOMIC TRANSACTION AND RELATED METHOD OF OPERATION

(71) Applicant: MAYPAY S.R.L., Roma (RM) (IT)

(72) Inventor: Andrea ORLANDI, Roma (RM) (IT)

(21) Appl. No.: 19/101,162

(22) PCT Filed: Sep. 14, 2023
(86) PCT No.: PCT/IB2023/059147

§ 371 Date: Feb. 4, 2025

(30) Foreign Application Priority Data
Sep. 20, 2022 (IT) 102022000019260

(51) Int. Cl. G06Q 30/0207; G06Q 20/06; G06Q 20/20; G06Q 20/24; H04L 67/55

(52) U.S. Cl. CPC G06Q 30/0212; G06Q 20/065; G06Q 20/20; G06Q 20/24; H04L 67/55

(57) ABSTRACT

Competition system for winning an economic transaction (100), adapted to be used by a user (1) in a commercial activity (2) affiliated with a manager (3) to have the opportunity to win part or all of the amount of one's own economic transaction (10) avoiding to pay it personally, characterized in that it comprises:—at least a web portal and/or application (110) adapted to allow said user (1) to enter their payment details, to be able to view said commercial activity (2), to be able to make online purchases, to participate in the competition procedure for winning the amount of said economic transaction (10) that is about to be carried out;—at least a cash device (120) used by said manager (3) to communicate with said web portal and/or application (110);—at least a pocket device (130) adapted to be used by said user (1) to exploit the system in the absence of a network connection.

### FIELD OF THE ART

The invention relates to the field of prize competitions and retail sales. Even more specifically, the invention is adapted to provide a system and a method adapted to provide the possibility of winning an economic transaction performed by a buyer.

### KNOWN ART

Nowadays, there are many technologies involved in providing services for general buyers of commercial activities. Smartpay services often offer coupons, discounts and other benefits adapted to ensure good customer loyalty. Prize competitions are also very widespread, such as mini-lotteries, receipt lotteries and similar, and generally tend to encourage purchases and also to build customer loyalty by providing a reward mechanism, often even with remote chances of winning.

There are many examples of patents which claim systems, methods and devices for providing services such as those just described.

One example is the object of patent application US2008020844A1 of H. J. PETTER. The invention relates to a system for influencing payment progress during a transaction. The system comprises a terminal arranged at a point of sale, adapted to provide an amount to be paid for the transaction; a lottery terminal, comprising a processing device, an operating device and a customer-side display device; and a lottery server, operatively connected to the lottery terminal. The lottery terminal is arranged to receive an order for the purchase of a lottery ticket, transmit a participation request to the server, receive a participation result, and, if the result indicates a prize, display a notice related to the prize on the first display device. The lottery server is arranged to receive a lottery participation request from the lottery terminal, provide a lottery participation result based on the lottery participation request, and transmit the lottery participation result to the lottery terminal.

The point of sale terminal is arranged to reduce, cancel or credit the amount to be paid for the transaction if the lottery participation result indicates a prize.

Another example is the object of patent application JP2005043982A of M. KAZUKO. The invention relates to a transaction system with prize competition. The invention aims to reduce each seller's expense burden related to a prize competition by having multiple sellers participate in the prize competition and burdening each seller with a prize or cash prize to be awarded to consumers who have applied to the prize competition.

The invention provides for a seller to be provided with an entry address and registration code as prize competition participation information to be issued to a consumer purchasing merchandise. A drawing is carried out on a network which is based on the registration code of the prize competition participation information to collect consumers. The drawing codes are issued to consumers participating in the prize competition, the drawing codes are tabulated to carry out a drawing processing, and a winning report is transmitted to the winning consumers. Furthermore, the registration fee, management fee, and registration code rental fee paid by the seller are tabulated and applied to part or all of the prize pool to be delivered to consumers. The inventions reported so far, by way of non-exhaustive example, are representative of the inventive-technological framework available to date.

The object of the present invention is to provide a system and a method for winning an economic transaction adapted to capable being detached from the logic of smart payments to move towards an almost gaming dimension. The invention allows the occurrence of the economic transaction by the customer to be made uncertain, because, in the event of a positive outcome of the random drawing, the same transaction will be conveyed from a third-party account with respect to that of the customer; such a third-party account will pay the purchase amount for the customer.

The invention therefore creates the possibility that an economic transaction towards the same account can come from more than one account, in an alternative manner, instead of from a single customer account as currently occurs.

The invention, although towards the field of gaming and gamification marketing, cannot be considered gaming nor the subject of gambling manifestations as it is completely free for buyers. The invention provides buyers who purchase goods and/or services of any kind from affiliated sellers with the opportunity to win the amount of their purchase, avoiding paying. In fact, with respect to other existing prize competitions, the invention carries out a check before issuing the receipt, thus allowing, in the event of a win, payment to the seller directly via the system. The invention is further characterized by a high winning rate ensured by the regenerative capacity of the system which draws its cash fund for the prize pool from the commissions on each individual transaction. Even more advantageously, the invention provides physical devices which allow a rapid interfacing between buyer and seller, solving the technical problem of communication even in the absence of network connectivity.

### DESCRIPTION OF THE INVENTION

According to the present invention, a competition system for winning an economic transaction and the method associated therewith are created. The system aims to revolutionize the payment step, allowing customers of any business, online and offline, to win what they are purchasing, thanks to an algorithm which continuously extracts “winners” among all the buyers.

The system is characterized by a high probability of winning ranging from 1 in 200 to 1 in 10, but the probability can be further increased or decreased. In fact, the system allows participating commercial businesses to personalize the probability of winning for their customers. The probability of winning can be shown or hidden from users on a dedicated web portal and/or application while also allowing users to filter and/or organize the display of sellers based thereon. The invention transforms the moment of payment into a moment of play, which among other things does not risk subjecting users to gambling addiction, as it does not require payment. The system thus aims to change the way of thinking about payment, transforming every purchasing experience into an exciting, fun and shareable moment. The user can decide whether to register their credit card in a web portal and/or application, or whether to use the portal and/or app to check the result of the drawing and then proceed with the payment with the method they prefer (online, by credit card, with cryptocurrencies, POS, cash, other). The winning transactions are paid by the system thanks to the commission paid by the merchants, while the service is completely free for users. Starting from digital payments, the system can reach the entire payment market, also including cash; in fact, the web portal and/or application can also be used before payment, to find out if it is necessary to pay or not.

In this case, the invention comes before the payment flow. However, if the user decides to pay via the web portal and/or application with a registered card, the payment flow is altered and the system completes it through the following steps:
sending the system the amount to be transferred to the merchant;
withdrawal pre-authorization for the indicated sum;
if the funds are present, extraction thereof;
in the event of a positive outcome, payment by the system to the merchant (or by third parties in order to ensure greater protection) and cancellation of the pre-authorized transaction;
in the event of a negative outcome, payment by the user according to the preferred method.

The software part therefore consists up of the web portal and/or the application which comprises a user section, a seller section, algorithms for the game, the payment flow and a cash fund for the prize pool, and plugins and/or applications specifically designed to be installed on cash registers and/or on computers with dedicated CMS (Customer Management System) for the direct interface with smartphones, tablets and similar. The invention generally encourages the purchase by also allowing customers to add commercial activities in a favorites list and receive notifications in the event of promotions activated by them. The logic of the possibility of winning triggers a reward mechanism which tends to build customer loyalty, to encourage them to return to the businesses participating in the service and to recommend them to friends.

The hardware part of the instead comprises a cash register device for merchants and a pocket device for users.

The pocket device is made with passive technology such as RFID, magnetic or similar, capable of being read by the reading unit of the cash register device when brought close thereto. Further, the cash register device comprises at least one numeric, alphanumeric and/or graphic code adapted to allow the user to scan it by means of their own mobile device such as, for example, a smartphone connected to the web portal and/or the application.

The system thereby allows the user to interact with said web portal and/or application both by means of their personal devices such as smartphones, tablets and similar, by scanning said code, and by using said pocket device in the event of a lack of network connection for the mobile devices.

Before making the purchase, the user, exploiting any of the identification methods available, identifies himself or herself, thus triggering, in the web portal and/or in the application, a mechanism by which a token is generated which then corresponds to a win or a loss. When the token is associated with a win, the user and the merchant immediately receive a notification, the merchant is paid by the system with the method he/she has configured as preferred, and the user wins their purchase, not paying. However, when the token is associated with a loss, a notification is sent once again, and the user pays for their purchase using the method they prefer. The data as well as the online transactions are protected with very high digital protection protocols which make the invention safe and reliable to use.

The advantages offered by the present invention are evident in the light of the description given up to now and will be even clearer thanks to the appended figures and the related detailed description.

### DESCRIPTION OF THE FIGURES

The invention will be described hereinafter in at least one preferred embodiment by way of non-limiting example with the aid of the appended figures, in which:

FIG. 1 shows a general view of the competition system for winning an economic transaction 100;

FIG. 2 shows a view of the method 200 of said competition system for winning an economic transaction 100.

### DETAILED DESCRIPTION OF THE INVENTION

The present invention will now be illustrated by way of a purely non-limiting or binding example, resorting to the figures which illustrate some embodiments with respect to the present inventive concept.

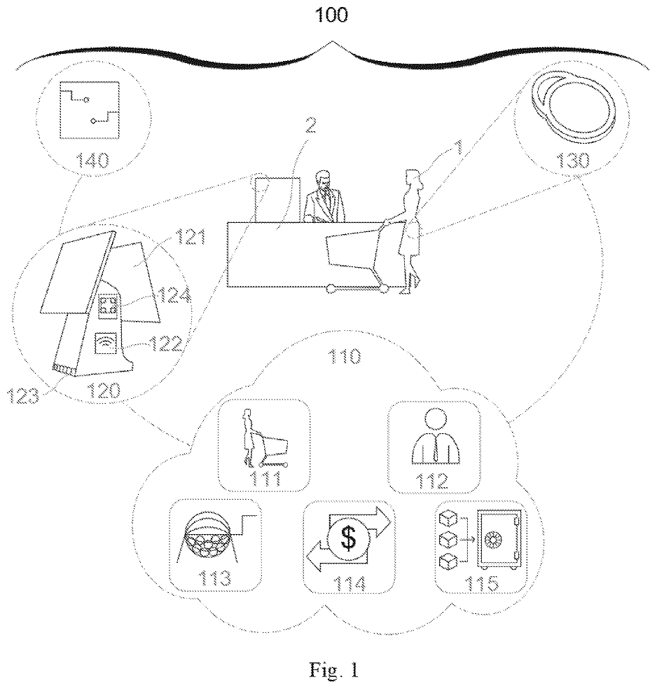

With reference to FIG. 1, a general view of said competition system for winning an economic transaction 100 according to the present invention is shown. In FIG. 1 as in the following description, the embodiment of the present invention currently considered the best is illustrated.

Said competition system for winning an economic transaction 100, adapted to be used by a user 1 in a commercial activity 2 affiliated with a manager 3 to have the opportunity to win up to the entire amount of their own economic transaction 10 avoiding paying for it personally, comprises at least a web portal and/or application 110 with at least a user section 111, a seller section 112, a game algorithm 113, a payment algorithm 114 and a prize fund money 115, at least one cash device 120 with at least one reading unit 121, a connection unit 122, LED lights 123, a code 124, at least one pocket device 130, at least one plugin and/or application 140.

Said web portal and/or application 110 is adapted to allow said user 1 to enter their payment details, to be able to view said commercial activity 2 nearby, to be able to make online purchases, to participate in the competition procedure for winning the amount of said economic transaction 10 that is about to be carried out. Said user section 111 is adapted to allow the configuration of a personal profile and the choice of preferred payment methods to complete remote purchases, said seller section 112 is adapted to provide said commercial activity 2 with the possibility of promoting its products and services, to show one's position, provide contact details, sell online, and set the payment preferences by the system when said user 111 wins or does not win the amount of said economic transaction 10. Said game algorithm 113 is adapted to generate random values for variables that determine a win or a loss of the possibility of receiving the amount of said economic transaction 10, said payment algorithm 114 is adapted to manage the payment of said economic transaction 10 by the system towards said commercial activity 2 in the event of victory or loss by said user 1. Said prize fund money 115 is adapted to be filled and emptied periodically on the basis of the transactions from which it receives a percentage, and on the basis of the victories for which it disburses part, or the entire sum of the payment of said economic transaction 10. Said prize fund money 115 is adapted to provide the possibility of dividing it into one or more reserve stocks from which money is withdrawn under conditions customized by the manager 3 such as, for example, a win which occurs in a moment of scarce presence of funds on the main stock.

Said cash device 120 is adapted to be used by said manager 3 to communicate with said web portal and/or application 110, it comprises said reading unit 121 which detects the presence of said pocket device 130 of said user 1, said connection unit 122 which connects to said web portal and/or application 110, said LED lights 123 adapted to send a signal in response to the connection with said web portal and/or application 110 and said numeric, alphanumeric and/or graphic code 124 which allows said user 1 to scan the same by means of their own mobile device such as a smartphone connected to said user section 111, to start communication with said web portal and/or application 110.

Said pocket device 130 is adapted to be used by said user 1 to exploit the system by initiating an interaction with said cash device 120 at the time of carrying out said economic transaction 10.

Said plugin and/or application 140 to be installed on cash registers, and/or on computers at said commercial activity 2 to allow the possibility of communicating directly with said web portal and/or application 110 via smartphone, tablet and other portable devices.

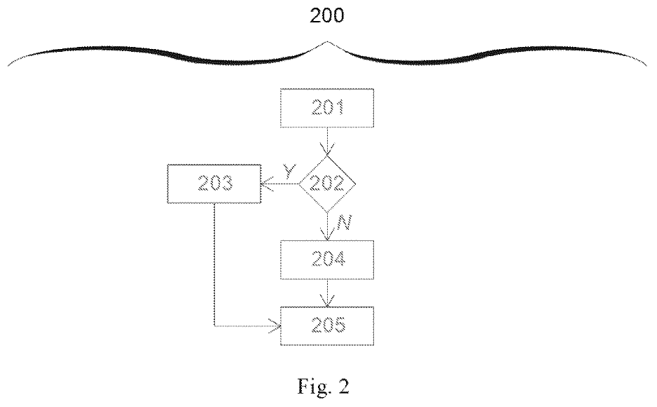

With reference to FIG. 2, a view is shown of said method 200 of said competition system for winning an economic transaction 100. Said method 200 will be described with reference to FIGS. 1 and 2.

Said method 200 is adapted to exploit said competition system for winning an economic transaction 100 according to the following steps, contact step 201, token generation step 202, payment step by the system or third party 203, payment step by the user 204, percentage acquisition step 205.

Said contact step 201 provides that said user 1 makes an online or on-site purchase at said commercial activity 2 and that the interaction is sent on said web portal and/or application 110. In said token generation step 202 said game algorithm 113 generates a token which can have a value resulting in a win or a loss. This step is adapted to have a positive (Y) or negative (N) outcome when the generated token corresponds to a winning value or not. When the token corresponds to a winning value (Y), the method 200 continues with a payment step by the system or third party 203. When the token corresponds to a losing value (N), the method 200 continues with a payment step by the user 204. Said payment step by the system or third party 203 provides that a green light signal is sent by said LED lights 123 of said cash device 120, that said payment algorithm 114 acquires the sum of said economic transaction 10 of said user 10 and pays it to said commercial activity 2 according to the preferences expressed in said seller section 112. Said payment step by the user 204 provides that a red light signal is sent by said LED lights 123 of said cash device 120, and that consequently, said user 1 pays for their own economic transaction 10.

In said percentage acquisition step 205, at the end of normal transactions between said user 1 and said commercial activity 2, the payment of said economic transaction 10 is received as a percentage by the system to fill said prize fund money 115. Said method 200 adapted to provide said percentage acquisition step 205 both after said payment step by the system or third party 203 and after said payment step by the user 204.

Said payment step by the system or third party 203 and said payment step by the user 204 also provide for sending a notification to said user 1 in said user section 111 and a notification to said commercial activity 2 in said seller section 112 and on said cash device 120.

Finally, it is clear that modifications, additions or variations which are obvious to a person skilled in the art can be made to the invention described up to now, without thereby departing from the scope of protection provided by the appended claims.

1. Competition system for winning an economic transaction (100), adapted to be used by a user (1) in a commercial activity (2) affiliated with a manager (3) to have the opportunity to win part or all of the amount of one's own economic transaction (10) avoiding to pay it personally, characterized in that it comprises:
at least a web portal and/or application (110) adapted to allow said user (1) to enter his/her payment details, to be able to view said commercial activity (2) nearby and the complete list of all affiliated commercial activities, to be able to make online purchases, to participate in the competition procedure for winning the amount of said economic transaction (10) that is about to be carried out;
at least a cash device (120) adapted to be used by said manager (3) to communicate with said web portal and/or application (110);
at least a pocket device (130) adapted to be used by said user (1) to exploit the system by initiating an interaction with said cash device (120) at the time of carrying out said economic transaction (10);
said web portal and/or application (110) comprising:
at least a user section (111) adapted to allow the configuration of a personal profile and the choice of preferred payment methods to complete remote purchases;
at least a seller section (112) adapted to provide said commercial activity (2) with the possibility to promote their products and services, to show one's position, provide contact details, sell online, and set the payment preferences by the system when said user (111) wins the amount of said economic transaction or pays through the system (10);
at least a game algorithm (113) adapted to generate random values for variables that determine a win or a loss of the possibility of receiving the amount of said economic transaction (10);
at least a payment algorithm (114) adapted to manage the payment of said economic transaction (10) by the system towards said commercial activity (2) in case of victory by said user (1);
at least a prize fund money (115) adapted to be filled and emptied periodically on the basis of the transactions from which it receives a percentage, and on the basis of the victories for which it disburses part, or the entire sum of the payment of said economic transaction (10); said prize fund money (115) adapted to be divided into one or more reserve stocks from which to withdraw money in customized conditions by said manager (3) such as a win that occurs in a moment of scarce presence of funds on the main stock;
said cash device (120) comprising:
at least a reading unit (121) adapted to detect the presence of said pocket device (130) of said user (1);
at least a connection unit (122) adapted to connect to said web portal and/or application (110);
at least some led lights (123) adapted to send a signal in response to the connection to said web portal and/or application (110).

2. Competition system for winning an economic transaction (100), according to the preceding claim 1, characterized in that said cash device (120) is adapted to comprise at least a numeric, alphanumeric and/or graphic code (124) adapted to allow said user (1) to scan the same by means of his/her own mobile device such as for example a smartphone connected to said user section (111), to start communication with said web portal and/or application (110).

3. Competition system for winning an economic transaction (100), according to the preceding claim 1, characterized in that said pocket device (130) is made with passive technology such as RFID, magnetic or the like, adapted to be read by said reading unit (121) when approached thereto.

4. Competition system for winning an economic transaction (100), according to claim 1, characterized in that it allows said user (1) to interact with said web portal and/or application (110) both through their personal devices such as smartphones, tablets and the like, by scanning said code (124), or by using said pocket device (130) in case of lack of network connection for mobile devices.

5. Competition system for winning an economic transaction (100), according to claim 1, characterized in that it comprises at least a plugin and/or application (140) to be installed on cash registers, and/or on computers at said commercial activity (2) to allow the possibility of communicating directly with said web portal and/or application (110) via smartphone, tablet and other portable devices.

6. Competition system for winning an economic transaction (100), according to claim 1, characterized in that it allows said commercial activity (2) to customize the probability of winning for its customers; the probability of winning may or may not be shown to said user (1) in said web portal and/or application (110) also allowing to filter and/or organize the display of sellers based on it.

7. Competition system for winning an economic transaction (100), according to claim 1, characterized in that it allows said user (1) to make digital payments, with cryptocurrencies, with credit cards and in cash.

8. Competition system for winning an economic transaction (100), according to claim 1, characterized in that it allows said user (1) to enter said commercial activity (2) in a list of favorites and to receive notifications in the event of promotions activated by it.

9. Competition system for winning an economic transaction (100), according to claim 1, characterized in that it provides the possibility that an economic transaction to the same account, such as that of said commercial activity (2), may come from more than one account in an alternative way, such as said prize fund money (115) and the account of said user (1), in the case, for example, of winning a part of the entire amount of said economic transaction (10).

10. Competition system for winning an economic transaction (100), according to any claim 1, characterized in that it comprises a proximity device adapted to intercept the presence of smartphones within a preset range of action to send push notifications to said identified smartphones, said notifications being adapted to inform passers-by or customers of the point of sale of the possibilities of winning through the system in question.

11. Method (200) of operation of a competition system for winning an economic transaction (100) according to claim 1, characterized in that it uses the system according to the following steps:
at least a contact step (201) in which said user (1) makes an online or on-site purchase at said commercial activity (2) and the interaction is sent on said web portal and/or application (110);
generation of a token (202), step in which said game algorithm (113) generates a token that can have a value resulting in a win or a loss; this step is adapted to have a positive (Y) or negative (N) outcome when the generated token corresponds to a winning value or not; when the token corresponds to a winning value (Y), the method (200) continues with a payment step by the system or third party (203); when the token corresponds to a losing value (N), the method (200) continues with a payment step by the user (204);
said payment step by the system or third party (203) provides that a green light signal is sent by said led lights (123) of said cash device (120), that said payment algorithm (114) acquires the sum of said economic transaction (10) of said user (10) and pays it to said commercial activity

(2) according to the preferences expressed in said seller section (112); said method (200) adapted to continue with a percentage acquisition step (205) subsequent to said payment step by the system or third party (203);
said payment step by the user (204) provides that a red light signal is sent by said led lights (123) of said cash device (120), and that consequently, said user (1) pays for his/her own economic transaction (10);
percentage acquisition step (205) provides that at the end of normal transactions between said user (1) and said commercial activity (2), and in any other transaction, the payment of said economic transaction (10) is received as a percentage by the system to fill said prize fund money (115).

12. Method (200) of operation of said competition system for winning an economic transaction (100), according to the preceding claim 11, characterized in that said payment step by the system or third party (203) and said payment step by the user (204) also provide for sending a notification to said user (1) in said user section (111) and a notification to said commercial activity (2) in said seller section (112) and on said cash device (120).
